(19) United States
(12) Patent Application Publication
(10) Pub. No.: US 2009/0035521 A1
(43) Pub. Date: Feb. 5, 2009

(54) Die consisting of PCBN or a CBN composite material comprising a clamping depression

(76) Inventors: Andreas Hafner, Goppingen (DE); Werner Weber, Leverkusen (DE); Matthias Muller, Kirchhelm (DE)

Correspondence Address: FULBRIGHT & JAWORSKI, LLP, 666 FIFTH AVE, NEW YORK, NY, 10103-3198, US

(21) Appl. No.: 10/568,491

(22) PCT Filed: Aug. 23, 2004
(86) PCT No.: PCT/EP04/09411

§ 371 Date: Sep. 19, 2006

(30) Foreign Application Priority Data
Aug. 22, 2003 (DE) 103 38 618.1
Aug. 23, 2003 (DE) 103 38 908.3
Feb. 27, 2004 (DE) 202004002977.4
Jul. 28, 2004 (DE) 102004036619.5

(51) Int. Cl. B32B 3/00; B29C 35/08

(52) U.S. Cl. 428/156; 264/497

(57) ABSTRACT

The invention relates to a die consisting of PCBN or a CBN composite material. To fix the die in a tool holder, said die comprises a clamping depression. The die is suitable for machining metals.

The invention relates to a cutting plate made from PCBN or a CBN composite material.

Cutting plates made from a ceramic material for machining metallic materials are used in a wide variety of fields of application. For some years polycrystalline cubic boron nitride has also been used as a material for such cutting plates. Polycrystalline cubic boron nitride, also called PCBN, is distinguished inter alia by an extremely high level of hardness. The properties of PCBN are described, for example, in the journal Werkzeuge, June 2001, on pages 16 to 20, or in the journal WB Werkstatt und Betrieb, Stefan Dillmann, Mischkeramik und PCBN im hartfeinen Duett, published by Carl Hanser Verlag, Munich, 6 Jun. 2002, 135th volume, and also in the field report Praxis-Report Nr. 19, Hartdrehen mit SPK-Wurbon und Mischkeramik, of CeramTec AG Innovative Ceramic Engineering, Geschäftsbereich SPK-Werkzeuge, Gottlieb-Haefele-Str. 7, D-73061 Ebersbach.

In addition to cutting plates that consist of solid PCBN material, there are, moreover, also cutting plates whose basic body consists of hard metal and whose surfaces are coated with polycrystalline cubic boron nitride.

If in the following there is talk of “a cutting plate/cutting plates made from PCBN”, both a cutting plate that contains PCBN as a solid material and a cutting plate whose basic body consists of hard metal and is coated on its surface with polycrystalline cubic boron nitride are to be understood thereby.

Furthermore, cutting ceramics are described that consist of a composite material made from silicon nitride and cubic boron nitride. This CBN composite material is described, for example, in EP 0 937 693 A1 and like PCBN is distinguished by an extremely high level of hardness.

If cutting plates are used, for example, for machining metal, the cutting plates must be secured in a gripping holder. Cutting plates that do not consist of PCBN or CBN materials are, for the purposes of securement in a gripping holder, often provided with a clamping trough, into which a gripping claw of the gripping holder engages in a clamping manner. As a result, a form-locking grip develops, as a result of which the cutting plate is fixedly anchored in the gripping holder.

Since cutting plates made from PCBN or CBN materials are extremely hard, the cutting plates that are known from the prior art and made from these materials are not provided with such clamping troughs. In the case of the cutting plates made from PCBN or CBN materials that are known from the prior art, a gripping holder that has a pressure plate resting on the cutting plate with pressure is used for the purposes of securement in a cutting tool. The disadvantage of this method is that in the event of unfavourable cutting it is possible for the cutting plate made from PCBN or a CBN composite material to slip out of the anchorage in the gripping holder or at least become loose.

Furthermore, in the case of the cutting plates made from PCBN or CBN materials known from the prior art, through-bores are also introduced in the centre of the cutting plate, by means of which bores the cutting plate can be fixed on the gripping holder. The disadvantage of this method is that the cutting plates are weakened by the boring and can ckrack or break.

The object of the present invention was therefore to provide cutting plates made from PCBN or CBN materials that can be reliably secured in a gripping holder without having the disadvantages of the prior art.

In accordance with the invention, this object is achieved in that the cutting plates made from PCBN or CBN materials are provided with a clamping trough. The cutting plates that are in accordance with the invention and made from PCBN or CBN materials with a clamping trough can be secured in a clamping manner in the gripping holder in this way like the conventional cutting plates not produced from these materials, by way of the gripping claw of the gripping holder. As a result, a form-locking grip develops, by means of which the cutting plates that are in accordance with the invention and made from PCBN or CBN materials with a clamping trough are fixedly anchored in the gripping holder. In this way it is no longer possible for the cutting plates that are in accordance with the invention and made from PCBN or CBN materials with a clamping trough to slip out of the cutting tool or to become loose.

The clamping trough that is provided in accordance with the invention can be produced, for example, in that the corresponding contour of the clamping trough is introduced by correspondingly shaping the green body, and the green body thus produced is dried and sintered.

The clamping trough that is provided in accordance with the invention can also be introduced subsequently, for example, by reworking the ready sintered cutting plate. Laser technology, grinding with suitable materials or else suitable etching processes are suitable, for example, for the subsequent introduction.

Basically, any configuration, as it is also known from the conventional ceramic cutting plates, is suitable as a clamping trough. Preferred clamping troughs are configured, for example, in the way that they are described in EP 0 075 177 B1 and in DE 102 08 266 A1.

The clamping trough that is described in DE 102 08 266 A1 is formed in a circular manner and in the centre has a spherical or circular elevation. A circular ring, adapted to this elevation, on the cam of the pressure piece embraces the elevation in the clamping trough, as a result of which the cutting plate is secured in a clamping manner in the gripping holder. As a result, optimum seating of the cutting plate in accordance with the invention in the cutting tool is guaranteed.

The cutting plates that are in accordance with the invention and made from PCBN or CBN materials with a clamping trough are preferably produced as indexable cutting plates, that is, the clamping trough that is provided in accordance with the invention is introduced on two opposing sides of the cutting plate.

On account of their extremely high level of hardness and their fixed seating in the cutting tool, the cutting plates that are in accordance with the invention and made from PCBN or CBN materials with a clamping trough are particularly good for particularly demanding applications that load the cutting plate to extremes. The rough-machining of grey cast iron may be mentioned by way of example. The cutting plates that are in accordance with the invention and made from PCBN or CBN materials with a clamping trough also bring about advantages in the case of less demanding applications as a result of the extension of the service lives.

1-10. (canceled)

11. A cutting plate comprising PCBN or a CBN composite material, wherein in that the cutting plate has a clamping trough.

12. The cutting plate according to claim 11, wherein the cutting plate has respective clamping troughs on two opposing sides.

13. The cutting plate according to claim 11, wherein that the clamping trough is formed in a circular manner and in the centre has a spherical or circular elevation.

14. A method for producing a cutting plate according to claim 11, wherein the corresponding contour of the clamping trough is introduced by correspondingly shaping the green body, and the green body thus produced is dried and sintered.

15. The method for producing a cutting plate according to claim 14 wherein the corresponding contour of the clamping trough is introduced into the cutting plate after sintering.

16. The method for producing a cutting plate according to claim 15, wherein the corresponding contour of the clamping trough is introduced into the cutting plate after sintering by means of laser technology.

17. The method for producing a cutting plate according to claim 15, wherein the corresponding contour of the clamping trough is introduced into the cutting plate after sintering by grinding.

18. The method for producing a cutting plate according to claim 15, wherein the corresponding contour of the clamping trough is introduced into the cutting plate after sintering by etching.

19. A method of making a metal comprising machining the metal with the cutting plate according to claim 22.

20. The method of claim 19, wherein the metal is grey cast iron.
